(19) United States
(12) Patent Application Publication
(10) Pub. No.: US 2012/0045027 A1
(43) Pub. Date: Feb. 23, 2012

(54) NOISE REDUCTION IN WIRELESS COMMUNICATION APPLICATIONS

(75) Inventor: Yoni Schif, Or Yehuda (IL)

(73) Assignee: CELLVINE Ltd., Or Yehuda (IL)

(21) Appl. No.: 13/254,846

(22) PCT Filed: Mar. 8, 2010
(86) PCT No.: PCT/IL10/00186

§ 371 Date: Sep. 4, 2011

Related U.S. Application Data
(60) Provisional application No. 61/158,363, filed on Mar. 8, 2009.

(51) Int. Cl. H04B 1/10

(52) U.S. Cl. 375/350

(57) ABSTRACT

A noise reduction system in a wireless communication network, including: two or more input antennas adapted to receive wireless signals; wherein each input antenna has a different receiving characteristic, so that the signals provided by the input antennas constitute a distinct combination of the received signals; a filter coupled to each of the input antennas except one, wherein the filter is adapted to estimate the correlation between the signal provided by its associated input antenna and the signal provided by the input antenna not coupled to a filter and mitigate a dominant component of the received signals responsive to the estimation; a summator that is adapted to combine the filtered signal and the signal provided by the input antenna not coupled to a filter and provide the result as feedback to the filter; and wherein the filtered signals from all the filters are combined to form an output signal.

### FIELD OF THE INVENTION

The present invention relates generally to a system and method of noise reduction in wireless communication networks.

### BACKGROUND OF THE INVENTION

Wireless communication networks are commonly used to transmit digital data. In many cases the wireless transmissions are susceptible to interferences in the transmission range, since other transmitters share the medium. Such interferences are especially common in dense urban environments, where many transmitters may be using common bandwidths. Additionally, interference may exist in military applications, where jamming devices may be used to deliberately interfere with transmissions. Further additionally, electromagnetic devices may unintentionally, provide noise that interferes with transmissions of a specific frequency.

When using repeaters, for example to enhance the range or intensity of desired transmissions, also the undesired transmissions are enhanced. As a result the opposite effect may be achieved, for example interference signals may become enhanced so that wireless communication cannot take place.

In some cases the interference may be more powerful than the transmission signals. A repeater that converts an input signal from analog to digital with a limited conversion range (e.g. 8-10 bits) to process the signal would waste most of the significant bits representing the interference signal, whereas the weaker communication signal would be represented only by a few of the bits and be represented with less accuracy, thus the dynamic range of the desired signal is reduced.

Accordingly, it would be desirable to design a device such as a repeater or signal preprocessor that can minimize or overcome the above two problems, namely mitigate external interference signals and improve the dynamic range of a digital representation of the transmitted signals of interest relative to the interference.

### SUMMARY OF THE INVENTION

An aspect of an embodiment of the invention, relates to a noise reduction system for use in a wireless communication network. The noise reduction system uses two or more antennas with distinct receiving characteristics, such that each antenna provides a distinct input signal that is a combination of the impending signals at the location of the noise reduction system. One of the input antennas serves as a base signal. The noise reduction system estimates the correlation between the signal provided by each antenna and the base signal to identify a dominant component of the signals and then mitigate the dominant component.

In an exemplary embodiment of the invention, a filter is coupled to each input antenna except the one providing the base signal. Optionally, the filter performs the estimation and mitigation. In an exemplary embodiment of the invention, a summator combines the filtered signal and the base signal and provides the combined signal as feedback to the filter. Optionally, all the filtered signals are combined together and an average of the combined signals is output from the noise reduction system. In some embodiments of the invention, the filters are adaptive filters. Optionally, the filters may be trained to identify specific signals and almost completely remove such signals, for example jamming signals or periodic interference signals.

In some embodiments of the invention, the input signals are converted from analog to digital before being filtered. Optionally, the base signal may either be converted to a digital representation or provided as an analog signal to enhance accuracy. In some embodiments of the invention, the digital representation of the base signal may include more bits of accuracy than the digital representation of the filtered signals.

In some embodiments of the invention, the output of the noise reduction system is transmitted wirelessly to a receiving device. Alternatively or additionally, the output of the noise reduction system is transmitted via a cable connection to a receiving device.

There is thus provided according to an exemplary embodiment of the invention, a noise reduction system in a wireless communication network, including:
two or more input antennas adapted to receive wireless signals; wherein each input antenna has a different receiving characteristic, so that the signals provided by the input antennas constitute a distinct combination of the received signals;
a filter coupled to each of the input antennas except one, wherein the filter is adapted to estimate the correlation between the signal provided by its associated input antenna and the signal provided by the input antenna not coupled to a filter and mitigate a dominant component of the received signals responsive to the estimation;
a summator that is adapted to combine the filtered signal and the signal provided by the input antenna not coupled to a filter and provide the result as feedback to the filter; and
wherein the filtered signals from all the filters are combined to form an output signal.

In an exemplary embodiment of the invention, all the signals provided by the input antennas are converted from analog to digital. Alternatively, only the signals provided by the input antennas that are coupled to a filter are converted from analog to digital. Optionally, the filters are adaptive filters. In an exemplary embodiment of the invention, the summator is an analog summator. Alternatively, the summator is a digital summator. Optionally, the noise reduction system further includes a signal generator adapted to provide a training signal for output from the noise reduction system. In an exemplary embodiment of the invention, the noise reduction system according further includes a controllable switch to prevent output of the input signals from the noise reduction system. In an exemplary embodiment of the invention, the output signal is transmitted wirelessly to a receiving device. Alternatively, the output signal is transmitted through a cable to a receiving device. Optionally, the system is adapted to be trained to identify characteristics of a signal and then mitigate the identified signal from further received signals.
There is further provided according to an exemplary embodiment of the invention, a method of reducing transmission noise in a wireless communication network, including:
   providing wireless signals using a device with two or more input antennas; wherein each input antenna has a different receiving characteristic, so that the signals provided by the input antennas constitute a distinct combination of the received signals;
   coupling a filter to each of the input antennas except one;
   estimating the correlation between the signal provided by its associated input antenna and the signal provided by the input antenna not coupled to a filter;
   mitigating a dominant component of the received signals responsive to the estimation to form a filtered signal; combining the filtered signal and the signal provided by the input antenna not coupled to a filter and provide the result as feedback to the filter; and
   forming an output signal by combining the filtered signals from all the filters.

### BRIEF DESCRIPTION OF THE DRAWINGS

The present invention will be understood and better appreciated from the following detailed description taken in conjunction with the drawings. Identical structures, elements or parts, which appear in more than one figure, are generally labeled with the same or similar number in all the figures in which they appear, wherein:

FIG. 1 is a schematic illustration of a noise reduction system, according to an exemplary embodiment of the invention;

FIG. 2 is a schematic illustration of a dominant signal, a typical signal and a digital bit template for sampling a combined signal, according to an exemplary embodiment of the invention;

FIG. 3 is a schematic block diagram of the control of a noise reduction system, according to an exemplary embodiment of the invention;

FIG. 4 is a schematic block diagram of the control of an alternative noise reduction system, according to an exemplary embodiment of the invention; and

FIG. 5 is a schematic block diagram of the control of a noise reduction system with more than two input antennas, according to an exemplary embodiment of the invention.

### DETAILED DESCRIPTION

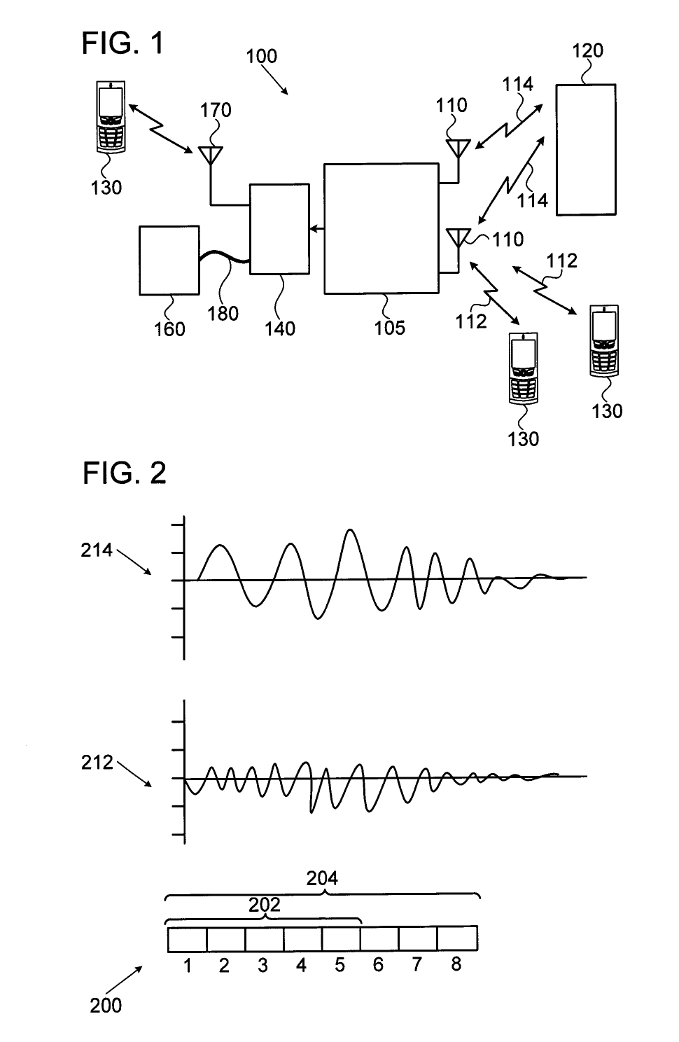

FIG. 1 is a schematic illustration of a noise reduction system 100, according to an exemplary embodiment of the invention. In an exemplary embodiment of the invention, noise reduction system 100 uses two or more input antennas 110 to accept wireless signals. Optionally, noise reduction system 100 includes a processing unit 105 to process the input signals and an output port 140 that is connected to an output antenna 170 and/or an output cable 180 to output the processed signal. Optionally, the processed signal is transmitted to the output port 140 and from there either transmitted wirelessly via output antenna 170 to remote receivers (e.g. mobile telephones 130) or transmitted via output cable 180 to another device 160 (e.g. a cellular base station or other communication devices). Optionally, noise reduction system 100 may be incorporated into the other device 160 to serve as the signal input of the device.

In an exemplary embodiment of the invention, each of input antennas 110 has a different receiving characteristic, so that the signals received by input antennas 110 will each be a distinct combination of the approaching signals, for example the input antennas 110 may be separated geometrically, have a distinct polarization factor or be influenced by other differentiating parameter.

FIG. 2 is a schematic illustration of a dominant signal 214, a typical signal 212 and a digital bit template 200 for sampling a combined signal made up from the two, according to an exemplary embodiment of the invention. In an exemplary embodiment of the invention, noise reduction system 100 serves as a repeater for wireless transmissions, for example signals transmitted by mobile telephones 130. Optionally, the desired signals are represented by typical signal 212 and other strong transmissions in the vicinity that are picked up by noise reduction system 100 are represented by dominant signal 214. In some embodiments of the invention, the dominant signals 214 may originate from an interference device 120, which may be an intentional interference device such as a signal jammer. Alternatively, dominant signal 214 may originate from a non-intentional interference device 120 such as an electronic device that produces undesirable signals of a specific bandwidth or range of bandwidths that coincide with the bandwidths of typical signal 212. Further alternatively, dominant signal 214 may originate from random interference.

In some embodiments of the invention, dominant signal 214 is stronger than typical signal 212, and input antennas 110 receive a linear combination of both signals. Optionally, straightforward conversion from analog to digital of the input signals would provide a digital representation of the signal wherein the undesired part of the signal (dominant signal 214) is represented by most of the bits of template 200 (e.g. bits 1-8 of template 200 designated by 204) and the desired part of the signal (typical signal 212) is only represented by a fraction of the bits (e.g. bits 1-4 of template 200 designated by 202).

In an exemplary embodiment of the invention, processing unit 105 is provided to mitigate dominant signal 214 so that its power level is closer to the power level of typical signal 212. Optionally, if dominant signal 214 is predictable, for example because it follows a pattern that can be studied when typical signal 212 is not applied, or prior knowledge is provided to processing unit 105, then dominant signal 214 can essentially be completely removed.

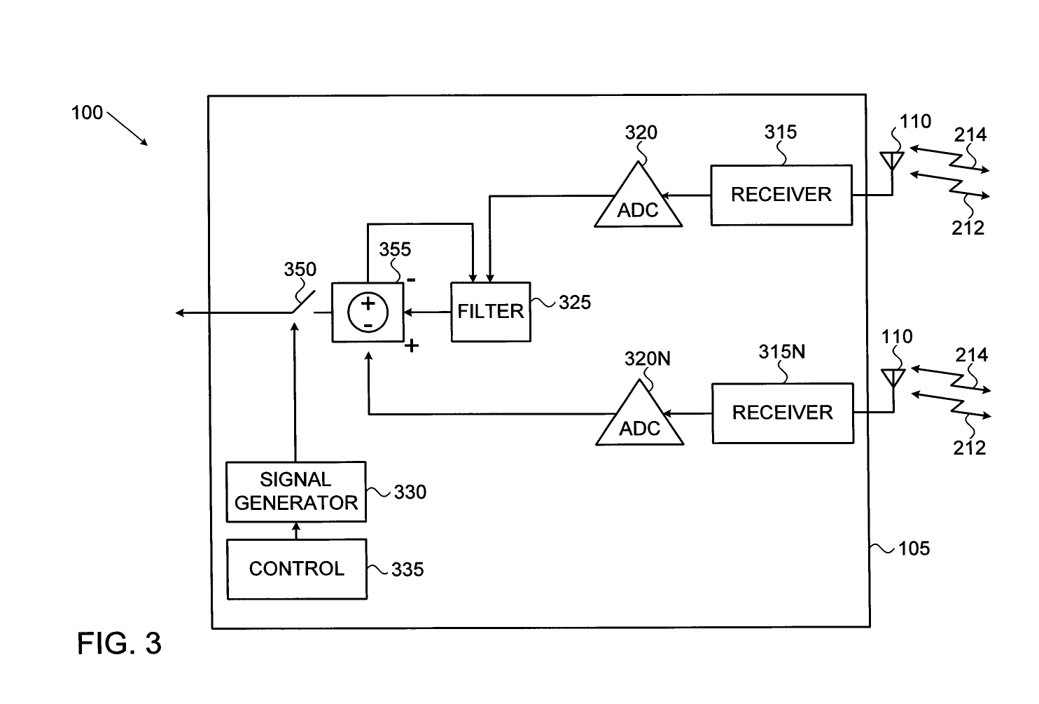

FIG. 3 is a schematic block diagram of noise reduction system 100, according to an exemplary embodiment of the invention. In an exemplary embodiment of the invention, the first input antenna 110, receives an input signal that is a combination of dominant signal 214 and typical signal 212. Optionally, the second input antenna 110 receives an input signal that is a different combination of dominant signal 214 and typical signal 212.

In an exemplary embodiment of the invention, the received signals are transferred from input antennas 110 to a first receiving unit 315 and a second receiving unit 315N. Optionally, the receiving units 315 and 315N include analog receiving circuitry, for example filters and low noise amplifiers. In an exemplary embodiment of the invention, the receiving units 315, 315N also include analog to digital converters (ADC) 320, 320N that may include basic digital filtering capabilities. In an exemplary embodiment of the invention, the digitized signal from the first receiving unit 315 is provided to a filter 325 which provides a filtered digitized signal. The filtered digitized signal and the digitized signal at the output of 320N are combined together and produce a combined signal (e.g. one subtracted from the other) to mitigate the dominant signal and to balance the power of the dominant signal 214 and typical signal 212 relative to each other. Optionally, filter 325 includes a digital processor to perform the calculations related to adaptation of filter 325 and applying filter 325 to the signal in real-time. Optionally, filter 325 is an adaptive filter that can be trained to enhance its ability to assure that the combined signal will have a reduced component of the dominant signal. In an exemplary embodiment of the invention, filter 325 produces a filtered signal that is provided to a summation element 355 to combine by adding or subtracting the filtered signal with the digitized signal from the second receiving unit 315N. Optionally, the adaptive filter 325 is trained to minimize the correlation between the input signal and the combined signal therefore the combined signal will contain a higher component of the desired signal and lower component of the dominant signal.

In an exemplary embodiment of the invention, processing unit 105 includes a signal generator 330, a control 335 and a switch 350, to control the use of processing unit 105. In some embodiments of the invention, switch 350 may be opened to prevent the summated signal from being output by processing unit 105 and in some cases switch 350 may be closed to allow the summated signal to be output by processing unit 105. Optionally, control 335 will instruct switch 350 if to open or close the switch. In an exemplary embodiment of the invention, when switch 350 is closed the summated signal is output to output port 140 so that it may transmit, filter and/or convert the output signal from digital to analog.

In some embodiments of the invention, the training of filter 325 is achieved by feeding the signal from the output of summation element 355 back into filter 325 to estimate the correlation between the combined signal and the signal received by first receiving unit 315. Optionally, by applying known training algorithms such as least mean square (LMS), recursive least square (RLS) or other methods, filter 325 can be perfected to achieve the desired mitigation of the dominant signal 214 and adjust the power of the dominant signal 214 relative to the typical signal 212. In an exemplary embodiment of the invention, the filtered signal is returned to summator 355 to output it to output port 140.

In some embodiments of the invention, switch 350 is opened during the training process of noise reduction system 100, so that no signal is output from noise reduction system 100 while it is being trained. Optionally, control 335 may instruct signal generator 330 to provide a pre-selected signal during training or at other times so that noise reduction system 100 will train to eliminate its own output signals, and prevent feedback interference.

When noise reduction system 100 handles cellular applications, for example serving as a repeater for mobile telephones, the position of the transmitters (e.g. mobile telephones) varies rapidly. Optionally, filter 325 may be updated frequently by applying a frequent training process. Optionally, training may be performed periodically or as a function of a signal to noise ratio (SNR) that is measured from the received transmissions, for example if the signal to noise ratio goes below a pre-selected value filter 325 will be re-trained.

In some embodiments of the invention, filter 325 does not have any prior knowledge to distinguish between the desired signals and undesired signals, so that filter 325 aims to mitigate the dominant signal and equate between the power of the dominant signal 214 and typical signal 212 based on an estimate or on a feedback process.

Alternatively or additionally, filter 325 may have prior knowledge regarding some of the parameters of the dominant signal 214 or the typical signal 212, for example the filter may know characteristics of a mobile telephone transmission and be able to use this knowledge to enhance mitigation of the dominant signal 214. Likewise dominant signal 214 may have a distinct “fingerprint” that can be used to filter out dominant signal 214. Optionally, filter 325 may be initially trained to identify the “fingerprint” of dominant signal 214, for example before the typical signals 212 are transmitted or in a different location where only the dominant signal is available. Optionally, filter 325 may be locked with this information for a specific period of time or it may be used as a starting point and afterwards trained dynamically. In some embodiments of the invention, the typical signals 212 may be turned off for a specific time period so that filter 325 may train with the dominant signal alone. Optionally, if the dominant signal 214 is identified or has a periodic pattern it may be almost completely removed

In some embodiments of the invention, the number of quantization bits used for the analog to digital conversion of the signal provided by first receiving unit 315 is not the same as the number of bits used for the second receiving unit 315N. Optionally, more bits are used for the second receiving unit 315N that is not filtered and fewer bits are used for the elements of the first receiving unit 315 and filter 325, thus improving the accuracy of the resulting signal without increasing the cost of the system significantly.

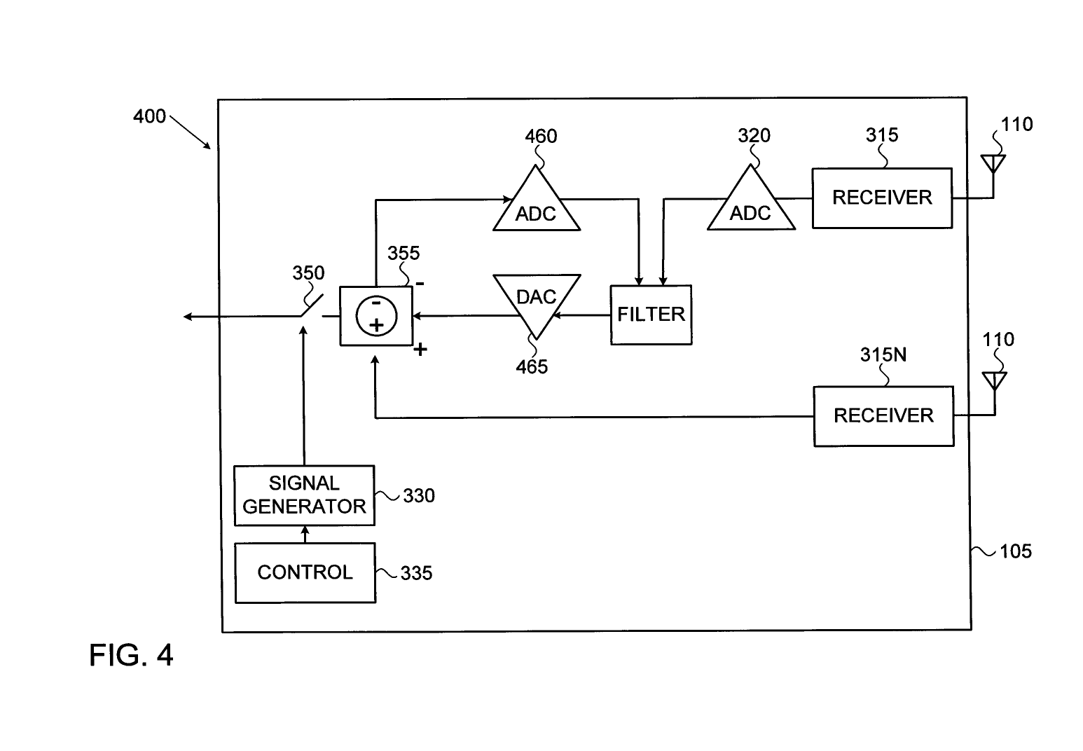

Taking this option one step further is achieved by replacing the second receiving unit 315N with an analog representation of the signal instead of enlarging the digitization resolution. FIG. 4 is a schematic block diagram of an alternative noise reduction system 400, according to an exemplary embodiment of the invention. Optionally, noise reduction system 400 is similar to noise reduction system 100 except that the second receiving unit 315N does not include an analog to digital converter. Additionally, since filter 325 is a digital filter, the output of filter 325 needs to be converted back to analog format with a digital to analog converter 465, so that it can be summated using an analog summator 455 with the signal from the second receiving unit 315N. Optionally, if the summated signal is provided as feed back to filter 325 it needs to be converted again to digital form by an analog to digital converter 460. In some embodiments of the invention, switch 350 supports analog signals instead of digital signals. Optionally, output port 140 is also designed to handle analog signals instead of digital signals.

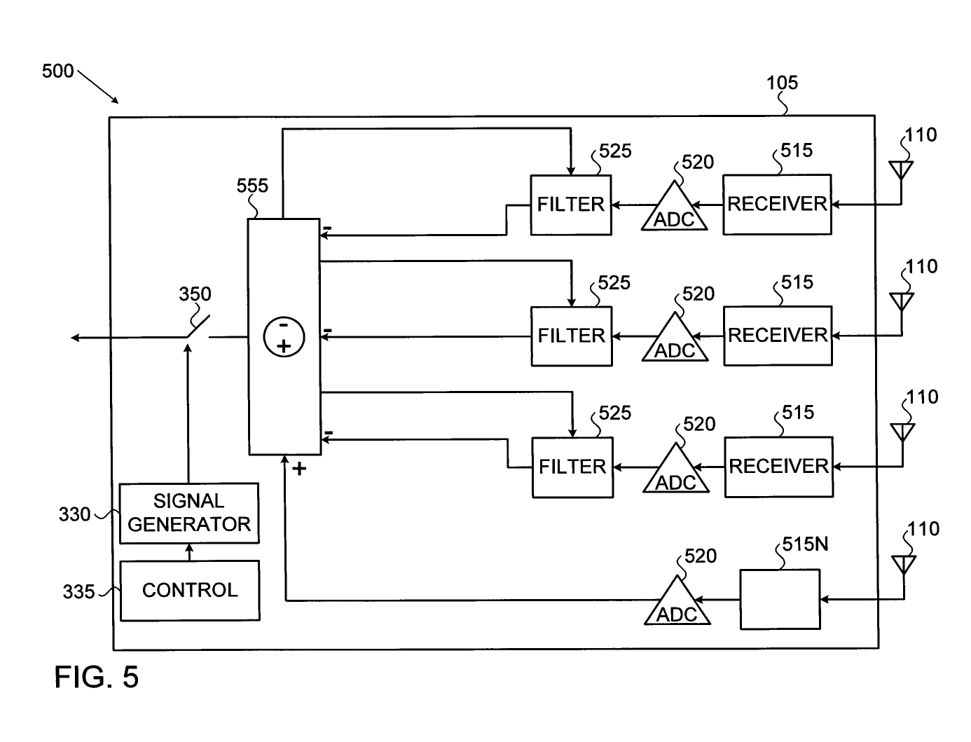

FIG. 5 is a schematic block diagram of the elements of a noise reduction system 500 with more than two input antennas 110 according to an exemplary embodiment of the invention. Optionally, noise reduction system 500 is similar to noise reduction system 300 except that it is designed to accommodate multiple input antennas 110. Optionally, each antenna 110 feeds a signal to a receiving unit 515. Optionally, each receiving unit 515 processes the signal converts it to a digital signal using an analog to digital converter 520 and provides the digitized signal to a filter 525. In an exemplary embodiment of the invention, a summator 555 accepts the signal from the last receiving unit 515N and combines it to the signal from each filter (e.g. by adding or subtracting the two signals). Optionally, the combined signal is provided to the corresponding filter 525 as feedback. Additionally, summator 555 combines the processed signals from all the filters and averages them out to form an output signal for providing to output port 140 via switch 350. Optionally, the use of additional input antennas 110 improve the accuracy of separating between the dominant signal 214 and the typical signal 212, so that the dominant signal may be mitigated. Optionally, the use of multiple antennas enables mitigation of multiple noise sources (e.g. up to N−1, where N is the number of antennas).

It should be appreciated that the above described methods and apparatus may be varied in many ways, including omitting or adding steps, changing the order of steps and the type of devices used. It should be appreciated that different features may be combined in different ways. In particular, not all the features shown above in a particular embodiment are necessary in every embodiment of the invention. Further combinations of the above features are also considered to be within the scope of some embodiments of the invention.

It will be appreciated by persons skilled in the art that the present invention is not limited to what has been particularly shown and described hereinabove. Rather the scope of the present invention is defined only by the claims, which follow.

1. A noise reduction system in a wireless communication network, comprising:
two or more input antennas adapted to receive wireless signals; wherein each input antenna has a different receiving characteristic, so that the signals provided by the input antennas constitute a distinct combination of the received signals;
a filter coupled to each of the input antennas except one, wherein the filter is adapted to estimate the correlation between the signal provided by its associated input antenna and the signal provided by the input antenna not coupled to a filter and mitigate a dominant component of the received signals responsive to the estimation;
a summator that is adapted to combine the filtered signal and the signal provided by the input antenna not coupled to a filter and provide the result as feedback to the filter; and
wherein the filtered signals from all the filters are combined to form an output signal.

2. A noise reduction system according to claim 1, wherein all the signals provided by the input antennas are converted from analog to digital.

3. A noise reduction system according to claim 1, wherein only the signals provided by the input antennas that are coupled to a filter are converted from analog to digital.

4. A noise reduction system according to claim 1, wherein the filters are adaptive filters.

5. A noise reduction system according to claim 1, wherein the summator is an analog summator.

6. A noise reduction system according to claim 1, wherein the summator is a digital summator.

7. A noise reduction system according to claim 1, further comprising a signal generator adapted to provide a training signal for output from the noise reduction system.

8. A noise reduction system according to claim 1, further comprising a controllable switch to prevent output of the input signals from the noise reduction system.

9. A noise reduction system according to claim 1, wherein the output signal is transmitted wirelessly to a receiving device.

10. A noise reduction system according to claim 1, wherein the output signal is transmitted through a cable to a receiving device.

11. A noise reduction system according to claim 1, wherein the system is adapted to be trained to identify characteristics of a signal and then mitigate the identified signal from further received signals.

12. A method of reducing transmission noise in a wireless communication network, comprising:
providing wireless signals using a device with two or more input antennas; wherein each input antenna has a different receiving characteristic, so that the signals provided by the input antennas constitute a distinct combination of the received signals;
coupling a filter to each of the input antennas except one;
estimating the correlation between the signal provided by its associated input antenna and the signal provided by the input antenna not coupled to a filter;
mitigating a dominant component of the received signals responsive to the estimation to form a filtered signal;
combining the filtered signal and the signal provided by the input antenna not coupled to a filter and provide the result as feedback to the filter; and
forming an output signal by combining the filtered signals from all the filters.
